(19) United States
(12) Patent Application Publication
(10) Pub. No.: US 2009/0097195 A1
(43) Pub. Date: Apr. 16, 2009

(54) HARD DISK DRIVE WITH VIBRATION ISOLATORS LOCATED AT MOUNTING POINTS

(75) Inventor: Thomas R. Colligan, San Jose, CA (US)

Correspondence Address: FISH & RICHARDSON P.C., PO BOX 1022, MINNEAPOLIS, MN, 55440-1022, US

(73) Assignee: Apple Inc., Cupertino, CA (US)

(21) Appl. No.: 11/872,463

(22) Filed: Oct. 15, 2007

(51) Int. Cl. G06F 1/16; A47B 81/00

(52) U.S. Cl. 361/679.34; 312/223.2

(57) ABSTRACT

A hard disk drive housing includes cavities where energy absorbing material (e.g., vibration isolators) can be inserted. In one aspect, cavities can be formed within the hard disk drive housing where mounting points are located for mounting the hard disk drive to a chassis. The cavities can be adapted (e.g., threaded) to receive threaded vibration isolators. The vibration isolators can be any size, shape (e.g., annular) and material (e.g., rubber) based on the intended design.

### TECHNICAL FIELD

The subject matter of this patent application is generally related to hard disk drive mounting.

### BACKGROUND

Standard computer hard disk drives can be mounted on vibration isolators. This often requires additional space external to the drive and a change to drive spacing, mounting brackets, etc. Designing a custom drive with internal vibration isolators would be expensive, and would preclude the changing of isolators for different mounting orientations, vibration sensitivities, etc.

### SUMMARY

A hard disk drive housing includes cavities where energy absorbing material (e.g., vibration isolators) can be inserted. In one aspect, cavities can be formed within the hard disk drive housing where mounting points are located for mounting the hard disk drive to a chassis. The cavities can be adapted (e.g., threaded) to receive vibration isolators. The vibration isolators can be any size, shape (e.g., annular) and material (e.g., rubber) based on the intended design.

### DESCRIPTION OF DRAWINGS

FIG. 1A is a top or a bottom view of an example hard disk drive housing including cavities for receiving vibration isolators.

FIG. 1B is a side view of an example hard disk drive housing including cavities for receiving vibration isolators.

FIG. 2A is a cross section, exploded view of an example hard disk drive housing including cavities for receiving vibration isolators.

FIG. 2B is a cross section, exploded view of an example hard disk drive housing, including a fastener fixedly attached to the cavity.

FIG. 3 is a flow diagram of a process for manufacturing a hard disk drive housing including cavities for receiving vibration isolators.

### DETAILED DESCRIPTION

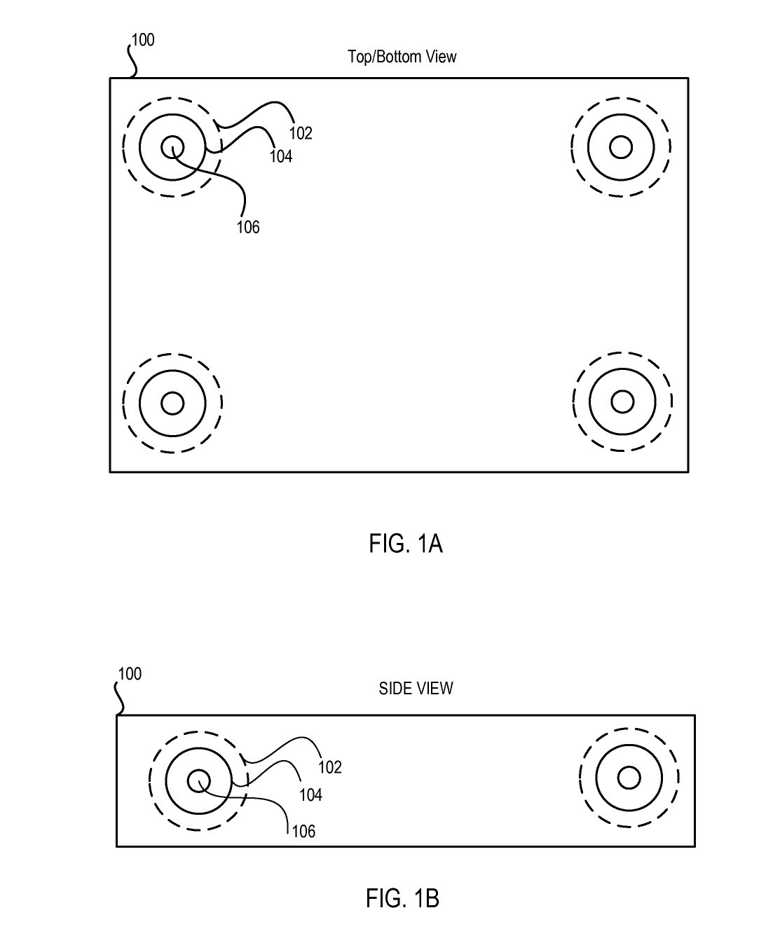

FIG. 1A is a top or a bottom view of an example hard disk drive housing 100 including cavities 102 for receiving energy absorbing materials (e.g., vibration isolators) 104. In this example, the vibration isolators 104 are annular or donut shaped, each having a mounting hole 106 surrounded by energy absorbing materials (e.g., rubber or elastomer, visco-elastic polymer). Vibration isolators 104 can also include dampeners, springs and/or other mechanical assemblies reducing shock or vibrations. In addition to attenuating vibrations, the vibration isolators 104 can reduce certain acoustical or impulsive noise (e.g., prominent discrete tones) as well as provide shock absorption. The shape and size of the vibration isolators 104, as well as their mounting points, can be selected to attenuate vibrations and other disturbances in three dimensions (e.g., x, y, z axes).

In some implementations, the vibration isolators 104 are inserted in the cavities 102 by drive manufacturers. This design allows a system integrator who is including the hard disk drive in its systems to mount the drive in multiple orientations without having to design or redesign vibration isolation mechanisms.

In some implementations, the cavities 102 are located at one or more mounting points on one or more mounting surfaces of the housing 100, and are adapted to receive the vibration isolators 104. In some examples, each of the vibration isolators 104 can be mounted to the hard disk housing 100 using a fastener (e.g., a screw). In some implementations, the vibration isolator 104 can be mounted to the housing 100 by inserting a screw through the mounting hole 106 in the vibration isolator 104, which can be screwed into a threaded receiving hole in the cavity 102. In some implementations, one or both of the cavity 102 or the mounting hole 106 can be threaded for receiving a threaded vibration isolator 104 or threaded fastener (e.g., a screw, etc.), respectively. In some implementations, other types of fasteners, such as clips, studs, compression fittings, DrivLok™ grooved pins, helicois, rivets, welds, tape, Velcro™, brackets, latches, adhesive, etc., can be used as fasteners to fix the vibration isolators 104 in the cavities 102.

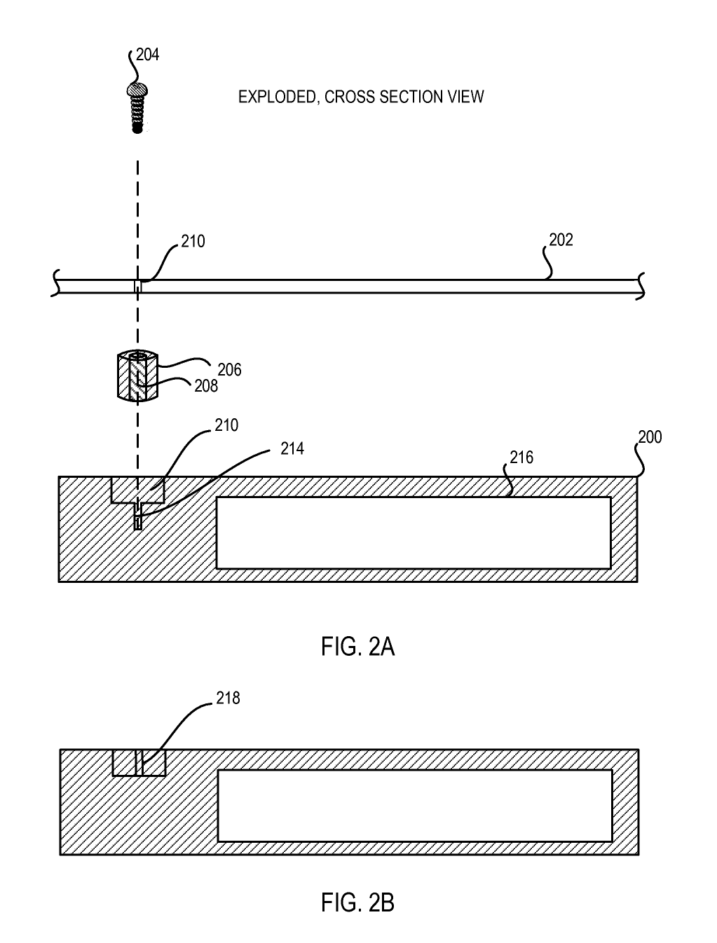

In some implementations, fasteners can be fixed perpendicular to the bottom of the cavity 102 and extend outward from the cavity 102. In such an arrangement, the vibration isolators 104 can be slipped over the fastener and a nut can be used to fasten the housing 100 and vibration isolator 104 to a bracket or other mounting assembly or structure. FIG. 2B shows such an implementation where a fastener 218 is attached to the bottom of the cavity and extends outward from the cavity. In some implementations, the fastener can be welded to the bottom of the cavity 102 or threaded into the mounting hole 106.

In some implementations, the cavities 102 can entirely surround the vibration isolators 104. For example, the depth of the cavities 102 can be at least as deep as the height of the vibration isolators 104 so that the vibration isolators 104 are entirely inserted into the cavities 102. Such an implementation may be suitable for use with a mounting post, for example. In other implementations, the cavities 102 may partially surround the vibration isolators 104. For example, a portion of a vibration isolator 104 may be exposed above the mounting surface of the housing 100 after being inserted in a cavity 102. Such an implementation may be suitable for mounting brackets or a drive cage, as described in reference to FIG. 2A.

Other mounting mechanisms can also be adapted for mounting the vibration isolators 104 in the cavities 102. In some implementations, the vibration isolators 104 can be removably fixed in the cavities 102 by friction. In one example, the vibration isolators 104 may be inserted into the cavity 102 by a compression fitting mechanism. After the vibration isolator 104 is inserted, the vibration isolator 104 can expand in size so that the vibration isolator 104 is held in the cavity 102 by a frictional force between the expanded vibration isolator 104 and the sides or surface of the cavity 102. In some implementations, the outer surface of the vibration isolator 104 and the sides or surface of the cavity 102 can include threads to fix the vibration isolator 104 in the cavity 102. In some examples, other mechanisms for fixing the vibration isolator 104 in the cavity 102 can be used (e.g., latching mechanisms).

In some implementations, the vibration isolators 104 can be bonded (e.g., glued or welded) to the cavities 102. In one example, the cavity surface may be covered with adhesive material before the vibration isolator 104 is inserted in the cavity 102. In another example, the vibration isolator 104 can be bonded on top of a mounting surface of the housing 100 proximate a mounting point.

Although the vibration isolators 104 are annular or donut shaped in the depicted example, in other examples, the vibration isolators 104 can have other shapes (e.g., square, oval) depending on the intended design.

Although four cavities 102 are shown to be located at the four corners of the housing 100 in FIG. 1, other locations for mounting the vibration isolators 104 are possible. In one example, the cavities 102 can be located at approximately the middle of each edge of the housing 100.

In some implementations, other mounting orientations can be used to mount the vibration isolators 104. For example, the vibration isolators 104 can be mounted along the sides of the hard disk housing 100 instead of, or in addition to, the top or the bottom of the hard disk housing 100. In other implementations, the vibration isolators 104 can be mounted on the top and sides of the hard disk housing 100 using angular or L-shaped brackets.

FIG. 1B is a side view of an example hard disk housing 100 including cavities 102 for vibration isolators 104. In the implementation shown in FIG. 1B, the vibration isolators 104 are mounted on the side of the housing 100. For example, the vibration isolators 104 can be mounted sideways into the cavity 102 using a mounting device, glue, or a compression fitting mechanism.

FIG. 2A is a cross section, exploded view of an example hard disk drive housing including cavities for vibration isolators. As shown in FIG. 2A, a disk drive system includes a hard disk housing 200 and a chassis bracket 202. The hard disk housing 200 contains a hard disk drive 216. The system includes a fastener 204 (e.g., a screw) for mounting the hard disk housing 200 to the chassis bracket 202. In some implementations, the hard disk housing 200 is mounted on posts, pedestals or mechanical mounting assemblies welded or otherwise coupled to the chassis.

The hard disk housing 200 includes a mounting surface and a cavity 210 formed in the mounting surface at a point where the hard disk housing 200 is mounted to the chassis bracket 202. In the depicted example, a vibration isolator 206 can be installed between the chassis bracket 202 and the hard disk housing 200. For example, the vibration isolator 206 is inserted in the cavity 210 to isolate the disk drive 216 from vibrations and other mechanical or acoustical disturbances received through the chassis bracket 202.

The vibration isolator 206 includes a mounting hole 208 for receiving the fastener 204 for mounting the hard disk housing 200 to the chassis bracket 202. In some implementations, the mounting hole 208 may be threaded to facilitate the insertion of the fastener 204. As shown in FIG. 2A, the cavity 210 also includes a threaded surface 214. The threaded surface 214 may be a threaded portion of the cavity 210 to receive the fastener 204. In some examples, the fastener 204 can be inserted through the chassis bracket through the cavity 210 and mounting hole 208 to the threaded surface 214. The threaded surface 214 can hold the fastener 204 in place so that the chassis bracket 202 and the vibration isolator 206 are firmly mounted to the hard disk housing 200, so as to isolate the hard disk 216 from vibrations and other mechanical or acoustical disturbances.

Although implementations are described in reference to FIGS. 2A and 2B, other implementations can also be used to mount the vibration isolator 206 and the hard disk housing 200 to the chassis bracket 202. For example, the system can include other structural components, such as washers, as part of the fastener. One or more washers can be included between the fastener 204 and the chassis bracket 202, between the chassis bracket 202 and the vibration isolator 206, and/or between the vibration isolator 206 and the bottom of the cavity 210.

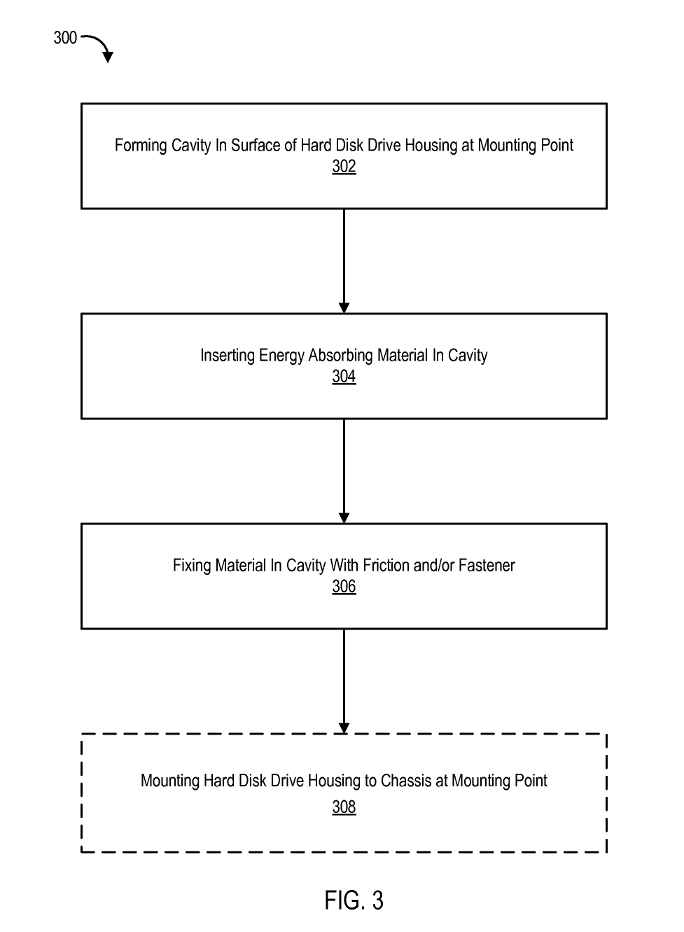

FIG. 3 is a flow diagram of a process 300 for manufacturing a hard disk drive housing including cavities for receiving vibration isolators. Some or all the steps of the process 300 can be performed by a disk drive manufacturer and/or a system integrator, for example.

In some implementations, the process 300 begins by forming a cavity in a surface of a disk drive housing at a mounting point (302). The cavity can partially or entirely surround the mounting point. The mounting point (e.g., a mounting hole) can be adaptable for mounting the disk drive housing to a chassis (e.g., mount to a personal computer chassis). The cavity can be formed in the housing die casting, stamping, milling, turning, drilling, threading, taps and dies, hand fabrication tools or any other known metal working tools or processes. The mounting hole can be made using threading, a drill press or any other known metal working tool or process.

Next, energy absorbing material is inserted in the cavity (304). For example, an annular (or other shaped) vibration isolator can be inserted in the cavity. The energy absorbing material can be removably or rigidly fixed in the cavity (306). In some implementations, the energy absorbing material can be removably fixed in the cavity using friction, Velcro™, adhesive tape or any other suitable material that would allow the material to be removed after insertion. In other implementations, the material can be rigidly fixed using a fastener, such as a screw, rivet, weld or adhesive.

Optionally, the hard disk drive housing can be mounted in a chassis at one or more mounting points, so that the energy absorbing material isolates the disk drive housing from vibration, shock or acoustical noise (308).

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A disk drive housing comprising:
a mounting surface having a mounting point; and
a cavity formed in the mounting surface at a mounting point for receiving energy absorbing material.

2. The disk drive housing of claim 1, where the cavity is formed to receive an annular vibration isolator.

3. The disk drive housing of claim 1, where the cavity is threaded for fixing a threaded annular vibration isolator in the cavity.

4. The disk drive housing of claim 1, where the cavity at least partially surrounds the mounting point.

5. The disk drive housing of claim 1, where the mounting point is a mounting hole for receiving a fastener.

6. The disk drive housing of claim 5, where the mounting hole is adapted for receiving a fastener from a group of fasteners consisting of: a screw, a clip, a stud, a compression fitting, a DrivLok™ grooved pin, a bracket, a latch, a helicoil, a rivet and adhesive.

7. A disk drive housing, comprising:
a mounting surface having a mounting point;
a cavity formed in the mounting surface at the mounting point; and
an energy absorbing material inserted in the cavity.

8. The disk drive housing of claim 7, where the energy absorbing material is an annular vibration isolator and the cavity is formed to receive the annular vibration isolator.

9. The disk drive housing of claim 8, where the cavity and vibration isolator are threaded for fixing the vibration isolator in the cavity.

10. The disk drive housing of claim 8, where the vibration isolator is removably fixed to the cavity by friction.

11. The disk drive housing of claim 7, where the mounting point is a mounting hole for receiving a fastener.

12. The disk drive housing of claim 11, where the fastener is one from a group of fasteners consisting of: a screw, a clip, a stud, a compression fitting, a DrivLok™ grooved pin, a bracket, a latch, a helicoil, a rivet and adhesive.

13. A system, comprising:
a chassis;
a disk drive mounted in the chassis, the disk drive having a housing with a mounting surface and a cavity formed in the mounting surface at a point where the disk drive is mounted to the chassis; and
energy absorbing material inserted in the cavity.

14. The system of claim 13, wherein the energy absorbing material includes a mounting hole for receiving a fastener for mounting the hard disk housing to the chassis.

15. A disk drive housing comprising:
a mounting surface having a mounting point;
a cavity formed in the mounting surface at a mounting point for receiving energy absorbing material; and
a fastener fixed to the bottom of the cavity and extending above the cavity for fixing energy absorbing material in the cavity.

16. A method comprising:
forming a cavity in a surface of a hard disk drive housing, wherein the cavity at least partially surrounds a mounting point on the surface, which mounting point is adaptable for mounting the hard disk drive housing to a chassis;
inserting energy absorbing material in the cavity; and
fixing the material in the cavity with friction or a fastener.

17. The method of claim 16, further comprising:
mounting the hard disk drive housing to a chassis at the mounting point, so that the material isolates the hard disk drive housing from vibration, shock or acoustical noise.
